(19) United States
(12) Patent Application Publication
(10) Pub. No.: US 2021/0400446 A1
(43) Pub. Date: Dec. 23, 2021

(54) SENSOR-INTEGRATED COMMUNICATION MODULE, CONTROL SYSTEM COMPRISING SAME, AND CONTROL METHOD

(71) Applicant: MIRO CO., LTD., Incheon (KR)

(72) Inventors: Dong Jin SEO, Incheon (KR); Yong Ju OH, Incheon (KR); Min Seok KIM, Incheon (KR)

(21) Appl. No.: 17/312,223

(22) PCT Filed: Apr. 23, 2019
(86) PCT No.: PCT/KR2019/004869

§ 371 Date: Jul. 7, 2021

(30) Foreign Application Priority Data
Dec. 10, 2018 (KR) 10-2018-0158493
Apr. 22, 2019 (KR) 10-2019-0046933

(51) Int. Cl. H04W 4/38; H04W 4/70; H04L 12/28

(52) U.S. Cl. CPC H04W 4/38; H04L 12/2832; H04L 12/2827; H04W 4/70

(57) ABSTRACT

A sensor-integrated communication module that is insertedly coupled to one side of a home appliance may include a communication unit for transmitting/receiving a signal to/from an external device by using wireless communication, a sensor unit for collecting ambient information, and a control unit for controlling an operation of the home appliance in consideration of the ambient information.

### TECHNICAL FIELD

The present invention relates to a sensor-integrated communication module for effectively controlling home appliances, a control system including the same, and a control method.

### BACKGROUND ART

Recently, in order to increase the convenience of a user, a technology to perform transmission and reception of various pieces of information through network connection has been implemented by mounting a communication module in home appliances in the home or a specific space, such as a refrigerator, a washing machine, an oven, an air conditioner, etc.

The communication module has been mounted and used on various types of home appliances as the price becomes cheaper, but the communication module is not mounted on small home appliances that do not have a high selling price.

In addition, in order to intellectualize the home appliances, the home appliances should be connected to sensors, but a lot of cost and time for developing separate sensors are required, and thus, there are practical difficulties.

### DISCLOSURE

### Technical Problem

In order to solve the aforementioned problems, an object of the present invention is to provide a sensor-integrated communication module which is applicable to small home appliances, a control system including the same, and a control method.

Another object of the present invention is to provide a sensor-integrated communication module which enables an intelligent control, a control system including the same, and a control method.

### Technical Solution

According to an aspect of the present invention, there is provided a sensor-integrated communication module that is insertedly coupled to one side of a home appliance, the sensor-integrated communication module including: a communication unit for transmitting/receiving a signal to/from an external device by using wireless communication; a sensor unit for collecting ambient information; and a control unit for controlling an operation of the home appliance in consideration of the ambient information.

The sensor unit may protrude outside the home appliance, and the sensor unit may be detachably installed.

The sensor unit may include a plurality of sensors, and the control unit may control the operation of the home appliance within a sensing value range corresponding to the external signal.

The communication unit may perform wireless communication with peripheral home appliances, and the control unit may provide a signal for controlling the operation of the peripheral home appliances in response to a request signal received from the external device.

The control unit may include an information collection unit for collecting signals received from the peripheral home appliances.

When the request signal may be received from the external device, controllable peripheral home appliances corresponding to the request signal may be selected, and the selected peripheral home appliances may be controlled.

The sensor-integrated communication module may include a display unit for displaying a connection state and a control state of the peripheral home appliances.

The external device may include a server or a user terminal.

According to another aspect of the present invention, there is provided a home appliance control system including: a home appliance; peripheral home appliances provided with a communication module; and a sensor-integrated communication module insertedly coupled to one side of the home appliance, in which the sensor-integrated communication module includes a communication unit for transmitting/receiving a signal to/from an external device and the peripheral home appliances by using wireless communication, a sensor unit for collecting ambient information, and a control unit for providing a signal that controls the operation of the peripheral home appliances in response to a request signal received from the external device.

The control unit may include an information collection unit for collecting signals received from the peripheral home appliances.

When the request signal may be received from the external device, controllable peripheral home appliances corresponding to the request signal may be selected, and the selected peripheral home appliances may be controlled.

The home appliance control system may include a display unit for displaying a connection state and a control state of the peripheral home appliances.

The external device may include a server or a user terminal.

The sensor unit may include a plurality of sensors, and the sensors may be detachably installed in the home appliance.

According to yet another aspect of the present invention, there is provided a home appliance control method including the steps of: receiving a request signal; controlling a home appliance in response to the request signal; selecting controllable peripheral home appliances; and controlling the selected peripheral home appliances.

In the selecting of the controllable peripheral home appliances, it may be determined whether the peripheral home appliances are home appliances suitable for the request signal.

When it is determined that the peripheral home appliances are suitable for the request signal, the corresponding peripheral home appliances may be selectively controlled.

In the selecting of the controllable peripheral home appliances, it may be determined whether the peripheral home appliances are present in a communicable range and whether the power of the peripheral home appliances is applied, to select the peripheral home appliances.

The home appliance control method may include displaying a connection state and a control state of the selected peripheral home appliances.

### Advantageous Effects

According to the present invention, it is possible to implement intelligent home appliances at low cost by providing the sensor-integrated communication module coupled to the home appliances.

Further, it is possible to provide a more pleasant environment by controlling the home appliances by using two or more sensing values.

Further, it is possible to effectively manage power by controlling the power to be supplied only when the sensor-integrated communication module operates.

Further, it is possible to maintain a pleasant space in accordance with a user's demand by controlling peripheral home appliances through wireless communication.

### DESCRIPTION OF DRAWINGS

FIG. 1 is a block diagram illustrating a home appliance control system according to a first embodiment.

FIG. 2 is a block diagram illustrating a sensor-integrated communication module provided in the home appliance control system according to the first embodiment.

FIG. 3 is a block diagram illustrating a home appliance control system according to a second embodiment.

FIG. 4 is a block diagram illustrating a sensor-integrated communication module provided in the home appliance control system according to the second embodiment.

FIGS. 5 and 6 are flowcharts illustrating an operation of the sensor-integrated communication module according to the second embodiment.

### BEST MODE

The present invention may have various modifications and various embodiments and specific embodiments will be illustrated in the drawings and described in detail in the detailed description. However, the present invention is not limited to specific embodiments, and it should be understood that the present invention covers all modifications, equivalents and replacements included within the idea and technical scope of the present invention. In describing each drawing, like reference numerals have been used for like components.

Terms including first, second, A, B, and the like are used for describing various components, but the components are not limited by the terms. The terms are used only to discriminate one component from the other component. For example, without departing from the scope of the present invention, a first component may be referred to as a second component, and similarly, the second component may be referred to as the first component. A term ‘and/or’ includes a combination of a plurality of associated disclosed items or any item of the plurality of associated disclosed items.

It should be understood that, when it is described that a component is “connected to” or “accesses” the other component, the component may be directly connected to or access the other component, or another component may be present therebetween. In contrast, it should be understood that, when it is described that a component is “directly connected to” or “directly accesses” the other component, it is understood that no component is present therebetween.

Terms used in the present application are used only to describe specific embodiments and are not intended to limit the present invention. A singular form may include a plural form unless otherwise clearly meant in the context. In the present application, it should be understood that the term “comprising” or “having” indicates that a feature, a number, a step, an operation, a component, a part or a combination thereof described in the specification is present but does not exclude a possibility of presence or addition of one or more other features, numbers, steps, operations, components, parts or combinations thereof, in advance.

Unless contrarily defined, all terms used herein including technological or scientific terms have the same meanings as those generally understood by those skilled in the art. Terms which are defined in a generally used dictionary should be interpreted to have the same meaning as the meaning in the context of the related art and are not interpreted as an ideal meaning or excessively formal meanings unless clearly defined in the present application.

Hereinafter, preferred embodiments of the present invention will be described in detail with reference to the accompanying drawings.

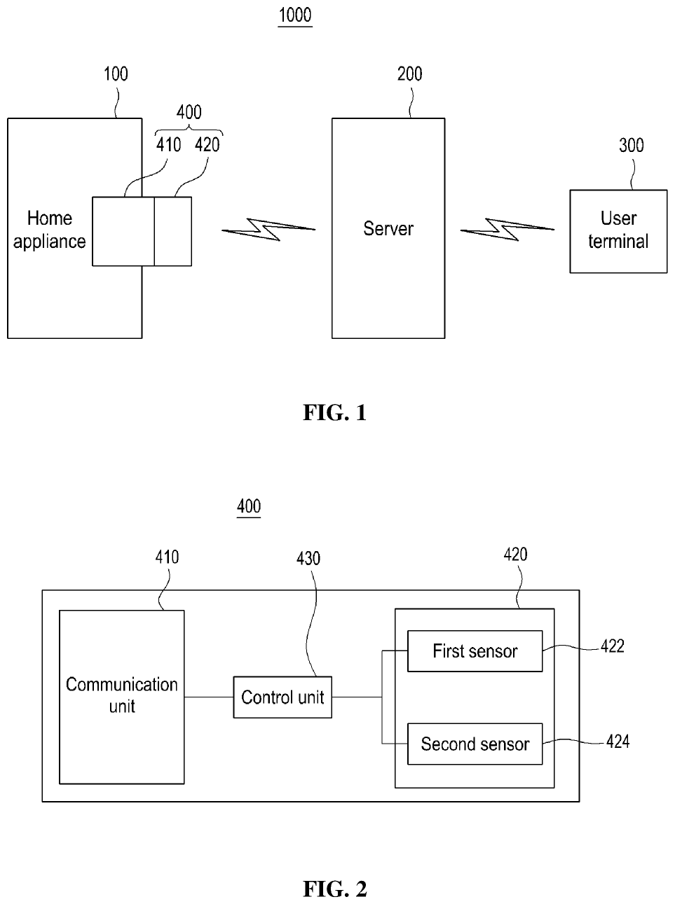

FIG. 1 is a block diagram illustrating a home appliance control system according to a first embodiment and FIG. 2 is a block diagram illustrating a sensor-integrated communication module provided in the home appliance control system according to the first embodiment.

Referring to FIGS. 1 and 2, a home appliance control system according to the first embodiment may include a sensor-integrated communication module.

The sensor-integrated communication module 400 may be coupled to one side of a home appliance 100. The sensor-integrated communication module 400 may be insertedly coupled to or slidably coupled to one side of the home appliance 100. The sensor-integrated communication module 400 may include a memory type. A storage space may be formed in a case of the home appliance 100 so that the sensor-integrated communication module 400 may be inserted.

The sensor-integrated communication module 400 may be electrically connected with the home appliance 100. The sensor-integrated communication module 400 may be coupled to the home appliance 100 to receive power from the home appliance. The sensor-integrated communication module 400 may perform wired communication with the home appliance 100.

The home appliance 100 may include a refrigerator, a cooking device, a washing machine, a cleaner, a water purifier, a cold/hot wind generator, a fan, a heater, an air conditioner, a humidifier, an air cleaner, and the like, but is not limited thereto.

The sensor-integrated communication module 400 may perform wireless communication with a server 200 or a user terminal 300. To this end, the sensor-integrated communication module 400 may include a communication unit 410. The communication unit 410 may be used by combining one or two or more of Wi-Fi, Bluetooth, ZigBee, G-Wave, RF, and infrared communication schemes.

The server 200 may include a server which is operated by a manufacturing company of the home appliance 100 or operated by a company entrusted by the manufacturing company, a server for services of the home appliance 100, a web server, and the like. The server 200 may transmit information on the home appliance 100 to the user terminal 300. The user terminal 300 may include a smartphone, an AI speaker, and the like. The communication unit 410 may transmit/receive signals to/from the server 200 in both directions.

Here, the communication unit 410 has transmitted/received the signals to/from the server 200 but may also directly transmit/receive the signals to/from the user terminal 300.

The sensor-integrated communication module 400 may include a sensor unit 420. The sensor unit 420 serves to collect ambient information. To this end, the sensor unit 420 may include one or two or more sensors. The plurality of sensors may include temperature, humidity, sound, light, dust, gas sensors, and the like.

The sensor unit 420 may be formed to protrude from the outside of the home appliance 100. The sensor unit 420 may be detachably installed. Since the sensor unit 420 may be detached from the sensor-integrated communication module 400, the sensor-integrated communication module 400 may be effectively manufactured according to a type of home appliance 100.

The sensor-integrated communication module 400 may include a control unit 430.

When a request signal is provided from the server 200, the control unit 430 may provide a control signal to the home appliance 100 in consideration of a sensing value measured from the sensor unit 420.

The sensor unit 420 may provide a control signal to the home appliance 100 in consideration of one sensing value. For example, when a user sets a room temperature to 25° C. through the user terminal 300, the control unit 430 may control the operation of the home appliance 100 so that the room temperature becomes 25° C. based on the sensing value of the sensor unit 420.

The control unit 430 may provide a control signal to the home appliance 100 in consideration of two or more sensing values. For example, when a request signal is received by the user so that the indoor may have a pleasant environment, the control unit 430 may control the operation of the home appliance 100 so as to maintain the room temperature to 24° C. to 26° C. and the room humidity to 50 to 60. To this end, the sensor unit 420 may include a first sensor 422 for measuring the temperature and a second sensor 424 for measuring the humidity. Here, a criterion of the pleasant environment may be preset by experiments.

The control unit 430 may verify whether the home appliance 100 is operated in a normal range of the sensing value of the first sensor 422 in response to the user's request signal. The control unit 430 may verify whether the home appliance 100 is operated in a normal range of the sensing value of the second sensor 424 when the sensing value of the first sensor 422 is in the normal range.

When the sensing value of the first sensor 422 is in the normal range and the sensing value of the second sensor 424 is not in the normal range, the operation of the home appliance 100 may be controlled so that the sensing value of the second sensor 424 is operated in the normal range.

When the sensing value of the first sensor 422 is not in the normal range and the sensing value of the second sensor 424 is in the normal range, the operation of the home appliance 100 may be controlled so that the sensing value of the first sensor 422 is operated in the normal range.

When the sensing value of the first sensor 422 is in the normal range and the sensing value of the second sensor 424 is in the normal range, the current operation of the home appliance 100 may be maintained.

When the sensing value of the first sensor 422 is not in the normal range and the sensing value of the second sensor 424 is also not in the normal range, the home appliance 100 may be operated so that any one of the sensing value of the first sensor 422 and the sensing value of the second sensor 424 first is in the normal range.

If a signal is not received from an external device, the control unit 430 may control the sensor-integrated communication module 400 not to be operated. When the signal is received from the external device, the control unit 430 may wake up the sensor-integrated communication module 400 to operate the sensor-integrated communication module 400.

According to the embodiment of the present invention, it is possible to implement intelligent home appliances at low cost by providing the sensor-integrated communication module 400 coupled to the home appliance 100.

Further, it is possible to provide a more pleasant environment by controlling the home appliance 100 by using two or more sensing values.

Further, it is possible to effectively manage power by controlling the power to be supplied only when the sensor-integrated communication module 400 operates.

As described above, the control of the home appliance 100 has been performed by the sensor-integrated communication module 400, but the control of the home appliance 100 may be performed through the server.

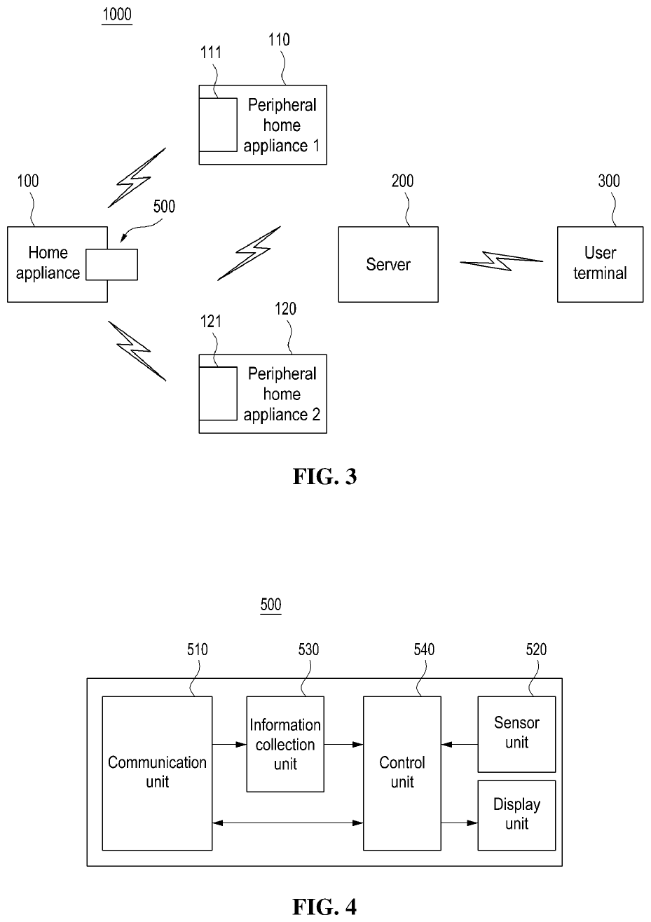

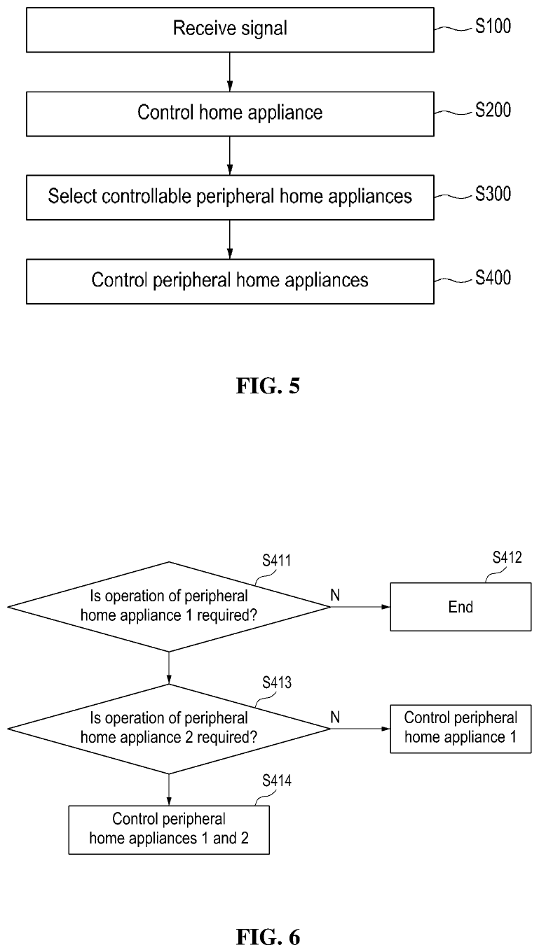

FIG. 3 is a block diagram illustrating a home appliance control system according to a second embodiment, FIG. 4 is a block diagram illustrating a sensor-integrated communication module provided in the home appliance control system according to the second embodiment, and FIGS. 5 and 6 are flowcharts illustrating an operation of the sensor-integrated communication module according to the second embodiment.

Referring to FIGS. 3 and 4, a home appliance control system 1000 according to the second embodiment may include a sensor-integrated communication module 500.

The sensor-integrated communication module 500 may be coupled to one side of a home appliance 100. The sensor-integrated communication module 500 may be insertedly coupled to one side of the home appliance 100 and may include a memory type.

The sensor-integrated communication module 500 may be electrically connected with the home appliance 100. The sensor-integrated communication module 500 may be coupled to the home appliance 100 to receive power from the home appliance.

The sensor-integrated communication module 500 may perform wired communication with the home appliance 100.

The sensor-integrated communication module 500 may include a communication unit 510. The communication unit 510 may be used by combining one or two or more of Wi-Fi, Bluetooth, ZigBee, G-Wave, RF, and infrared communication schemes.

The sensor-integrated communication module 500 may perform wireless communication with peripheral home appliances 110 and 120. The sensor-integrated communication module 500 may perform wireless communication with a server 200 or a user terminal 300. The server 200 may transmit information on the home appliance 100 to the user terminal 300.

The home appliance 100 and the peripheral home appliances 110 and 120 may include a refrigerator, a cooking device, a washing machine, a cleaner, a water purifier, a cold/hot wind generator, a fan, a heater, an air conditioner, a humidifier, an air cleaner, and the like, but are not limited thereto.

The server 200 may include a server which is operated by a manufacturing company of the home appliance 100 or operated by a company entrusted by the manufacturing company, a server for services of the home appliance 100, a web server, and the like.

The user terminal 300 may include a smartphone, an AI speaker, and the like. Here, the communication unit 510 has transmitted/received the signals to/from the server 200 but may also directly transmit/receive the signals to/from the user terminal 300.

The sensor-integrated communication module 500 may include a sensor unit 520. The sensor unit 520 serves to collect ambient information. To this end, the sensor unit 520 may include one or two or more sensors. The plurality of sensors may include temperature, humidity, sound, light, dust, gas sensors, and the like. The sensor unit 520 may be formed to protrude from the outside of the home appliance 100. The sensor unit 520 may be detachably installed on the sensor-integrated communication module 500.

The sensor-integrated communication module 500 may include an information collection unit 530.

The information collection unit 530 may collect signals received from the home appliance 100 and the peripheral home appliances 110 and 120. The information collection unit 530 may be divided into a plurality of information collection units so as to store information of the home appliance 100 and information of the peripheral home appliances 110 and 120, respectively. The information collection unit 530 may store signals received from the server 200 or the user terminal 300. The information collection unit 530 may be a memory for storing the received signals.

The sensor-integrated communication module 500 may include a control unit 540.

The control unit 540 may transmit the information of the home appliance 100 or a sensing value of the sensor unit to the server 200 through the communication unit 510. The control unit 540 may collect the information of the peripheral home appliances 110 and 120 to transmit the collected information to the server 200.

When a request signal is received from the server 200 through the user terminal 300, the control unit 540 may provide signals so as to change the operation of the home appliance 100 by the request signal.

The control unit 540 may provide signals to the peripheral home appliances 110 and 120 through the communication unit 510 so as to change the operation of the peripheral home appliances 110 and 120.

The sensor-integrated communication module 500 may include a display unit.

The display unit may display a connection state and a control state of the home appliance 100 and the peripheral home appliances 110 and 120. The display unit may include a flickering LED or an LCD which displays the connection state and the control state of the home appliance 100 and the peripheral home appliances 110 and 120 in texts or figures.

Hereinafter, an operation of the sensor-integrated communication module 500 will be described with reference to FIGS. 5 and 6. A reference numeral of each component may be designated with reference to FIG. 4.

As illustrated in FIG. 5, the control unit 540 may perform receiving a signal (S100). The control unit 540 may receive a signal from the server 200 or the user terminal 300. The received signal may be a user's request signal. The request signal may be a signal capable of controlling the operation of the home appliance 100. The request signal may be a request signal including temperature and humidity or a signal of a pleasant environment, a cool environment, or the like.

The control unit 540 may perform controlling the home appliance 100 when the signal is received (S200). The control unit 540 may operate the home appliance 100 by the user's request signal. For example, when the request signal is a specific temperature signal, the control unit 540 may control the home appliance 100 so that the indoor has a specific temperature.

The control unit 540 may perform selecting the controllable peripheral home appliances 110 and 120 (S300). The control unit 540 may confirm the presence of the peripheral home appliances 110 and 120 through wireless communication and confirm whether there are controllable peripheral home appliances 110 and 120 according to the request signal and then select the peripheral home appliances 110 and 120. That is, the control unit 540 may confirm whether the controllable peripheral home appliances 110 and 120 are present in a communication distance, or are devices suitable for the user's request signal.

For example, if the request signal is a signal of requesting a pleasant indoor environment, the control unit 540 may select the peripheral home appliances 110 and 120 corresponding to a cold/hot wind generator, a humidifier, and an air cleaner to provide the pleasant indoor environment. At this time, if any one of the peripheral home appliances 110 and 120 is present in an incommunicable distance or is not connected with the power, the home appliance may not be selected.

While the peripheral home appliances 110 and 120 are present in an incommunicable distance or are not connected with the power, the control unit 540 may notify this situation through the communication unit 510 or the display. That is, the display may display a connection state and a control state of the peripheral home appliances 110 and 120.

The control unit 540 may perform controlling the selected peripheral home appliances 110 and 120 (S400). The control unit 540 may control the peripheral home appliances 110 and 120 suitable for the request signal.

As illustrated in FIG. 6, the control unit 540 may perform determining whether an operation of the peripheral home appliance 1 110 is required (S411). The peripheral home appliance 1 110 may be a humidifier for adjusting the humidity. The control unit 540 may perform the control of the peripheral home appliance 1 110 based on the humidity measured from the sensor unit 520.

For example, if the humidity measured from the sensor unit 520 satisfies a humidity required by the user, the control unit 540 may control the peripheral home appliance 1 110 not to be operated or to terminate the operation (S412).

On the other hand, if the humidity measured from the sensor unit 520 does not satisfy the humidity required by the user, the peripheral home appliance 1 110 may be operated.

The control unit 540 may perform determining whether an operation of the peripheral home appliance 2 120 is required (S413). The peripheral home appliance 2 120 may be an air cleaner for cleaning air. The control unit 540 may perform the control of the peripheral home appliance 2 120 based on the air cleanliness measured from the sensor unit 520.

For example, if the air cleanliness measured from the sensor unit 520 satisfies criteria required by the user, the control unit 540 may control the peripheral home appliance 2 120 not to be operated or to terminate the operation. That is, the control unit 540 controls only the peripheral home appliance 1 110.

If the air cleanliness measured from the sensor unit 520 does not satisfy criteria required by the user, the control unit 540 may operate both the peripheral home appliance 1 110 and the peripheral home appliance 2 120.

In the home appliance control system according to the second embodiment, it is possible to maintain a pleasant space according to a user's demand by controlling the peripheral home appliances through wireless communication.

1. A sensor-integrated communication module that is insertedly coupled to one side of a home appliance, the sensor-integrated communication module comprising:
a communication unit for transmitting/receiving a signal to/from an external device by using wireless communication;
a sensor unit for collecting ambient information; and
a control unit for controlling an operation of the home appliance in consideration of the ambient information.

2. The sensor-integrated communication module of claim 1, wherein the sensor unit protrudes outside the home appliance, and the sensor unit is detachably installed.

3. The sensor-integrated communication module of claim 2, wherein the sensor unit includes a plurality of sensors, and the control unit controls the operation of the home appliance within a sensing value range corresponding to the external signal.

4. The sensor-integrated communication module of claim 1, wherein the communication unit performs wireless communication with peripheral home appliances, and the control unit provides a signal for controlling an operation of the peripheral home appliances in response to a request signal received from the external device.

5. The sensor-integrated communication module of claim 4, wherein the control unit includes an information collection unit for collecting signals received from the peripheral home appliances.

6. The sensor-integrated communication module of claim 5, wherein when the request signal is received from the external device, controllable peripheral home appliances corresponding to the request signal are selected, and the selected peripheral home appliances are controlled.

7. The sensor-integrated communication module of claim 6, further comprising:
a display unit for displaying a connection state and a control state of the peripheral home appliances.

8. The sensor-integrated communication module of claim 1, wherein the external device includes a server or a user terminal.

9. A home appliance control system comprising:
a home appliance;
peripheral home appliances provided with a communication module; and
a sensor-integrated communication module insertedly coupled to one side of the home appliance,
wherein the sensor-integrated communication module includes a communication unit for transmitting/receiving a signal to/from an external device and the peripheral home appliances by using wireless communication, a sensor unit for collecting ambient information, and a control unit for providing a signal that controls an operation of the peripheral home appliances in response to a request signal received from the external device.

10. The home appliance control system of claim 9, wherein the control unit includes an information collection unit for collecting signals received from the peripheral home appliances.

11. The home appliance control system of claim 10, wherein when the request signal is received from the external device, controllable peripheral home appliances corresponding to the request signal are selected, and the selected peripheral home appliances are controlled.

12. The home appliance control system of claim 9, further comprising:
a display unit for displaying a connection state and a control state of the peripheral home appliances.

13. The home appliance control system of claim 9, wherein the external device includes a server or a user terminal.

14. The home appliance control system of claim 9, wherein the sensor unit includes a plurality of sensors, and the sensors are detachably installed in the home appliance.

15. A home appliance control method comprising steps of:
receiving a request signal;
controlling a home appliance in response to the request signal;
selecting controllable peripheral home appliances; and
controlling the selected peripheral home appliances.

16. The home appliance control method of claim 15, wherein in the selecting of the controllable peripheral home appliances, it is determined whether the peripheral home appliances are home appliances suitable for the request signal.

17. The home appliance control method of claim 16, wherein when it is determined that the peripheral home appliances are suitable for the request signal, the corresponding peripheral home appliances are selectively controlled.

18. The home appliance control method of claim 16, wherein in the selecting of the controllable peripheral home appliances, it is determined whether the peripheral home appliances are present at a communicable distance and whether power of the peripheral home appliances is applied, to select the peripheral home appliances.

19. The home appliance control method of claim 15, further comprising:
displaying a connection state and a control state of the selected peripheral home appliances.
